(19) United States
(12) Patent Application Publication
(10) Pub. No.: US 2018/0204283 A1
(43) Pub. Date: Jul. 19, 2018

(54) SYSTEMS AND METHODS FOR GENERATING A NAVIGATION TOOL FOR ROUTING BETWEEN MULTIVARIATE DATASETS

(71) Applicant: FeeX Wisdom of the Crowds Ltd., Herzliya (IL)

(72) Inventors: Eyal HALAHMI, Kfar Netter (IL); Yoav ZUREL, New York, NY (US); David WEISZ, New York (IL); Uri LEVINE, Tel-Aviv (IL)

(21) Appl. No.: 15/741,782

(22) PCT Filed: Jul. 7, 2016
(86) PCT No.: PCT/IL2016/050729

§ 371 Date: Jan. 4, 2018

Related U.S. Application Data
(60) Provisional application No. 62/189,320, filed on Jul. 7, 2015.

(51) Int. Cl. G06Q 40/06; G06Q 40/04; G06Q 10/04

(52) U.S. Cl. CPC G06Q 40/06; G06Q 10/04; G06Q 40/04

(57) ABSTRACT

There is provided a method of generating a navigation tool, comprising: managing a similarity dataset mapping a documented similarity distance between each pair of multivariate datasets, each one of the multivariate datasets comprising documented values of service parameters; receiving a current multivariate dataset comprising current values of the service parameters; identifying, using the similarity dataset, a group of the multivariate datasets such that a similarity distance between each member thereof and the current multivariate dataset is below a threshold; instructing a rendering of a comparison graphical user interface presenting a comparison between at least some of the documented values of at least some of the service parameters for each member of the group; identifying a selection user made with the comparison graphical user interface of a selected member of the group; and instructing a rendering of additional information about the selected member in response to the selection user.

### BACKGROUND

The present invention, in some embodiments thereof, relates to systems and methods for management of multivariate datasets and, more specifically, but not exclusively, to systems and methods for generating a navigation tool for navigation of the multivariate datasets.

Investors, such as individuals saving for retirement or for other goals, may choose from a large number of different financial investment vehicles. For example, in the United States, there are about 75000 investment funds, which include, for example, mutual funds, exchange traded funds, and real estate investment trusts, and thousands of individual stocks, bonds, and other investment vehicles. Each investor may acquire one or multiple vehicles for inclusion in a portfolio, for example, included as part of a 401(K) retirement plan, or an individual retirement account (IRA). Each vehicle is different, holding different financial assets, charging different fees, and having different historical performances.

### SUMMARY

According to an aspect of some embodiments of the present invention there is provided a method of generating a navigation tool, comprising: managing a similarity dataset mapping a documented similarity distance between each pair of a plurality of multivariate datasets, each one of the plurality of multivariate datasets comprising a plurality of documented values of a plurality of service parameters; receiving a current multivariate dataset comprising a plurality of current values of the plurality of service parameters; identifying, using the similarity dataset, a group of the plurality of multivariate datasets such that a similarity distance between each member thereof and the current multivariate dataset is below a threshold; instructing a rendering of a comparison graphical user interface presenting a comparison between at least some of the plurality of documented values of at least some of the plurality of service parameters for each member of the group; identifying a selection user made with the comparison graphical user interface of a selected member of the group; and instructing a rendering of additional information about the selected member in response to the selection user.

Optionally, the method further comprises presenting to a user a plurality of filter parameters and filtering the plurality of multivariate datasets according to at least one selected filter parameter form the plurality of filter parameters. Optionally, at least some of the filter parameters are selected from the plurality of service parameters.

Optionally, identifying is performed using a plurality of weights each defined for one of the plurality of service parameters.

Optionally, the documented similarity distance is calculated by summing an outcome of a plurality of different distance estimation functions each defined for one of the plurality of service parameters.

Optionally, the documented similarity distance is calculated as a Euclidian distance in a multidimensional space defined by the service parameters, wherein each dataset is represented as a point according to respective values of the service parameters. Optionally, the threshold is defined as a predefined number of datasets nearest to the current dataset.

Optionally, the plurality of service parameters comprise a term parameter, a quality parameter and a type parameter.

Optionally, the method further comprises identifying a subgroup of the group of the plurality of multivariate datasets according to a combination requirement that balances a tradeoff between the similarity distance and improvement in respective value of a predefined service parameter.

Optionally, the comparison further includes a comparison of a simulated forecast for a future time frame based on at least some of the service parameter values.

Optionally, the method further comprises identifying, using the similarity dataset, a subgroup of the group of the plurality of multivariate datasets according to a value of a certain service parameter being below a second threshold.

Optionally, the method further comprises identifying, using the similarity dataset, a subgroup of the group of the plurality of multivariate datasets according to a simulated forecast for a future time frame, the simulated forecast based on at least some of the service parameter values.

Optionally, each dataset represents a different financial investment vehicle, and the current multivariate dataset represents a certain financial investment vehicle owned by the user. Optionally, at least one of the service parameters is selected from the group consisting of: actual financial assets held by the vehicle, investment strategy, investment category, purchase of derivatives and/or other leveraging instruments, exchange currency risk, transaction activity. Optionally, the comparison includes a comparison of a simulated financial forecast for a future time frame representing a future balance of the user. Optionally, the certain financial investment vehicle of the user is part of a 401(K), wherein the different financial investment vehicles include at least some vehicles which are part of an IRA, and the comparison includes a comparison of rolling over from the 401(K) to the IRA. Optionally, at least one of the different financial investment vehicle and the certain financial investment vehicle are a repackaged vehicle.

Optionally, at least some values of the similarity distances are calculated in response to receiving the current multivariate dataset.

According to an aspect of some embodiments of the present invention there is provided a system for generating a navigation tool, comprising: a network interface for communicating over a network with a plurality of client terminals each associated with at least one physical user interface; a data repository storing a similarity database mapping a documented similarity distance between each pair of a plurality of multivariate datasets, each one of the plurality of multivariate datasets comprising a plurality of documented values of a plurality of service parameters; a program store storing code; and a processor coupled to the network interface, the data repository, and the program store for implementing the stored code, the code comprising: code to receive a current multivariate dataset comprising a plurality of current values of the plurality of service parameters; code to identify, using the similarity database, a group of the plurality of multivariate datasets such that a similarity distance between each member thereof and the current multivariate dataset is below a threshold; code to render a comparison graphical user interface presenting a comparison between at least some of the plurality of documented values of at least some of the plurality of service parameters for each member of the group; code to transmit the comparison graphical user interface to a first client terminal of the plurality of client terminals for presentation on a respective at least one physical user interface; code to identify a selection user made using the at least one physical user interface with the comparison graphical user interface of a selected member of the group; code to render additional information about the selected member in response to the selection user; and code to update the comparison graphical user interface presented on the first client terminal to display the additional information.

Optionally, the system further comprises code to access an external server to parse online materials from the external server and arrange the parsed online materials to obtain the values for the plurality of service parameters.

Optionally, the first client terminal comprises a mobile device and the respective at least one physical user interface comprises a touch-screen.

Optionally, the multivariate dataset stores at least one multivariate object representing fees, the multivariate object including one or more service parameters selected from the group consisting of: expense ratio, recurring fees, one time fees, commission, wrap fees, transaction fees, advisor fees, and miscellaneous operating fees.

Optionally, the system further comprises code to analyze data submitted from a plurality of users of the plurality of client terminals, to estimate values of at least some of the service parameters.

Optionally, the system further comprises code to estimate values of at least some of the service parameters for a certain dataset according to values of service parameters of at least one other dataset, wherein the at least one other dataset represents an underlying dataset of the certain dataset.

According to an aspect of some embodiments of the present invention there is provided a computer program product comprising a non-transitory computer readable storage medium storing program code thereon for implementation by a processor of a system for generating a navigation tool, the program code comprising: instructions to manage a similarity database mapping a documented similarity distance between each pair of a plurality of multivariate datasets, each one of the plurality of multivariate datasets comprising a plurality of documented values of a plurality of service parameters; instructions to receive a current multivariate dataset comprising a plurality of current values of the plurality of service parameters; instructions to identify, using the similarity database, a group of the plurality of multivariate datasets such that a similarity distance between each member thereof and the current multivariate dataset is below a threshold; instructions to render of a comparison graphical user interface presenting a comparison between at least some of the plurality of documented values of at least some of the plurality of service parameters for each member of the group; instructions to identify a selection user made with the comparison graphical user interface of a selected member of the group; and instructions to render additional information about the selected member in response to the selection user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a process of generating a navigation tool for navigating datasets, in accordance with some embodiments of the present invention;

FIG. 2 is a block diagram of components of a system that generates a navigation tool, receives user input from a comparison GUI, and renders additional information about a selected dataset according to the user input, in accordance with some embodiments of the present invention;

FIG. 3 is a data diagram of different data components for implementation of the method of FIG. 1 and/or used by the system of FIG. 2, in accordance with some embodiments of the present invention;

FIGS. 4A-F are screen captures of an exemplary implementation of the method of FIG. 1, and/or the system of FIG. 2, in accordance with some embodiments of the present invention; and

FIGS. 5A-5F are another set of screen captures of an exemplary implementation of the method of FIG. 1, and/or the system of FIG. 2, in accordance with some embodiments of the present invention.

### DETAILED DESCRIPTION

The present invention, in some embodiments thereof, relates to systems and method for management of multivariate datasets and, more specifically, but not exclusively, to systems and methods for generating a navigation tool for navigation of the multivariate datasets.

An aspect of some embodiments of the present invention relates to systems and/or methods (e.g., code implementable by a processor) for navigating between multivariate datasets including documented values of service parameters, according to user input provided using data entry elements of a graphical user interface (GUI) accessed using a physical user interface. Optionally, each dataset represents data associated with a certain financial investment vehicle, stored as values of the service parameters. A statistical similarity, optionally a similarity distance, between each vehicle owned by the user (e.g., held in a portfolio) and available vehicles is calculated based on service parameters represented by multivariate objects of each dataset representing each vehicle. A group of similar datasets may be identified according to a close statistical similarity (optionally the closest similarity distances) to the user dataset being analyzed. The set of similar datasets represents datasets that are most similar to the user dataset. The GUI is rendered to present a comparison between the user dataset and one or more of the identified similar datasets, by presenting at least some of the values of the service parameters.

Optionally, a subset of suggested datasets may be selected from the set of similar datasets based on one or more factors and/or service parameters that are improved in each suggested dataset as compared to the user dataset, for example, vehicle related fees (e.g., total fees), and/or vehicle financial performance (e.g., total financial returns). The improvement may be defined by a similarity distance of a certain service parameter (or set thereof), which is furthest away from the user dataset, for example, largest difference in fees. The set of suggested vehicles may be selected based on a balance (e.g., delicate balance) between similarity with the user vehicle and improvement relative to the user vehicle. The suggested vehicle with the optimal balance between similarity and improvement may be designated as a top choice for presentation to the user (optionally along with other suggested vehicles). The set of suggested dataset are presented on the GUI in association with the user dataset. In this manner, the user is presented with a set of vehicles that are similar to the user vehicle, but which provide an improvement in one or more service parameters (and/or other factors). Replacement of the currently held user vehicle with another vehicle from the set of vehicles may improve financial performance while meeting set objectives. The user may replace the current vehicle with the optimal vehicle, achieving a balance between remaining as close as possible to the current vehicle, while achieving as great of an improvement as possible.

The statistical similarity may be calculated based on a statistical distance calculated between each pair of multivariate datasets. Alternatively or additionally, the statistical distance is calculated between current values of a current multivariate dataset (e.g., received from the user) and the datasets. The statistically distance may be calculated according to values of the service parameters represented by the multivariate objects of each dataset, optionally represented in an abstract multi-dimensional space, optionally a Euclidean space. The statistical distance may be calculated by summing an outcome of different distance estimation functions each defined for one of the service parameters, optionally a Euclidean distance, optionally a weighted Euclidean distance, or optionally a simple sum. The statistical distance may be calculated from a dataset based on a financial investment vehicle held by the user (e.g., in a portfolio, such as a retirement plan) to one or more investment vehicles that are available to the user (e.g., which the user may purchase or switch to), for example, publicly available vehicles, vehicles the 401(K) of the user, and vehicles in other retirement plans which the user may roll over to.

Optionally, the user may use the GUI to change one or more filter parameters that filter the multivariate datasets. The filters may be applied to the closest datasets and/or to the subset of suggested datasets. The filter parameters may include one or more of the service parameters of the vehicles, for example, type parameter (e.g., exchange traded fund, mutual fund, stock fund, bond fund, balanced fund, stock, and bond), term parameter (e.g., bond term), and quality parameter (e.g., quality of debt instruments the vehicle invests in). Alternatively or additionally, the filter parameters may include one or more other parameters (i.e., not service parameters and/or derived from service parameters), for example, estimated future performance, and/or vehicle broker. In this manner, vehicles of the selected type are considered in the suggested vehicles.

The user may change a similarity requirement (e.g., threshold) that defines which vehicles (datasets) are included with the set of similar datasets (e.g., considered for inclusion in the set of suggested datasets), for example, when a correlation value (or statistical distance) is on a scale of 0-1, the requirement may be a cutoff of similarity distance above 0.9. In another example, when a statistical distance is a normalized value, on a scale of 0-1, where 0 represents no distance (i.e., identical) and 1 represents a maximum distance, the requirement may be a cutoff of similarity distance below 0.1. The requirement may be defined as below a threshold, above a threshold, or other requirements, for example, the top 10 (or 20 or other number) in increasing similarity distance. The requirement may be defined as a combination of similarity distance and improvement parameters (e.g., one or more service parameters and/or other factors, such as fees), for example, defining an optimal combination striking a balance between the tradeoff of being as close of a distance as possible while improving one or more parameters as much as possible. For example, the closer the potential vehicle is to the user vehicle the more similar the improvement parameter, and the further the potential vehicle the greater the improvement in the parameter, with the combination requirement defining the tradeoff between distance and improvement parameters. An option may be provided in which there is not predefined requirement, for example, when the datasets are presented in increasing distance from the user dataset.

Optionally, the user may change a similarity requirement (e.g., threshold) that defines which datasets are included in the subset of suggested datasets, selected from the set of similar datasets. Alternatively or additionally, the user may change which service parameters (or other factors) are used to select the subset of suggested datasets. Alternatively or additionally, the similarity requirement for selection of the suggested dataset is a predefined system configuration, which may not be changed by the user.

The subset of suggested datasets may be selected from the similar dataset according to a similarity distance measured based on a set of service parameters (and/or other factors) between members of the similar dataset and the user dataset. The subset of suggested datasets may be selected from the similar dataset according to absolute values of one or more service parameters and/or other factors. The subset may be selected according to a requirement, such as a threshold (e.g. below or above), a predefined number of members, and/or based on decreasing or increasing order of value (and/or distance), and/or absolute value of the service parameter. The service members may include, for example, fees, actual vehicle return, and simulation of future returns. For example, the set of similar datasets may include 50 members. The subset of suggested datasets may be selected as the top 10 members of the similar dataset having lowest fees.

Optionally, the suggested vehicles are selected according to a simulation of a forecast for a future time frame, for example, number of years until retirement. The service parameters may be simulated for the future time frame. Selection of the suggested vehicles is performed according to the simulation, comparing the suggested vehicle to a simulation of the user vehicle, for example, predicting total fees paid over the next 30 years, and/or financial returns over the next 30 years.

The systems and/or methods described herein address the technical problem of providing easy (or improving) user navigation between multivariate datasets having multivariate data objects. The multivariate datasets represent data of financial investment vehicles. The multivariate data objects may represent different service parameters of each vehicle, each optionally assigned a value. The large number of available financial investment vehicles (e.g., about 75000 investment funds in the United States alone, along with thousands of individual stocks, bonds, and other financial vehicles) present an unmanageable dataset to a user for selection of particular vehicles for inclusion in an investment portfolio. Moreover, as each investment vehicle differs from one another in one or more service parameters, comparison of different vehicles (e.g., in a 1-1 manner) results in a very large number of possible combinations, which cannot be reviewed and/or analyzed by the user. The systems and/or methods described herein provide an interactive GUI that navigates between different multivariate datasets according to real-time user inputs, such as the user pressing one or more buttons or entering data in one or more fields of the GUI. The GUI is presented on a physical user interface, such as a display, optionally a touch-screen. The user enters data using a physical user interface, which may be the touch-screen, or a keyboard, mouse, or other physical device.

The systems and/or methods described herein may improve performance of a computing system, such as a client terminal, network, and/or network server, for example, by reducing processor utilization, reducing data traffic over the network, and/or by reducing storage requirements. Improvements may occur, for example, by the navigation between different multivariate datasets according to real-time user entered data, as compared to, for example, the user manually accessing different data servers to obtain individual data items relate to the multivariate datasets, and/or to processing and/or presentation of large dataset that aggregate a large number of the different multivariate datasets (i.e., instead of the routing).

The systems and/or methods described herein may generate new data (which may be presented to the user on the GUI, stored, and/or transmitted to another server) that include a representation of financial investment vehicles as a set of multivariate datasets including multivariate objects assigned values representing service parameters. The new data may include a similarity database that maps documented similarity distances between the multivariate datasets (i.e., financial investment vehicles), which may be used to identify the closest datasets to a current dataset of the user, as described herein.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the term vehicle or financial investment vehicle may sometimes be interchangeable with the term dataset, for example, when the dataset is a representation of the vehicle. Vehicles may include individual investment vehicles, for example, stocks, bonds, and other monetary notes. Vehicles may include managed funds, for example, mutual funds, index funds, and exchange traded funds.

As used herein, terms similarity score and similarity distance are sometimes interchangeable for example, when referring to criteria for selection of datasets relative to the user dataset, for presentation to the user. Sometimes the terms similarity score and similarity distance are used to refer to particular methods of performing the selection, for example, similarity score referring to how close the datasets are to one another (e.g. on a scale of 0-1, 1 denoting identical and 0 denoting completely different or opposite) and similarity distance referring to the distance (e.g., Euclidean distance) between datasets (e.g., on a scale of 0-1, 1 denoting the greatest distance and 0 denoting no distance). In such a case, it is understood that similarity score and similarity distance may be sometimes interchangeable, as different methods may be used in the selection. One method may be described for clarity, with the understanding that the other method may be substituted.

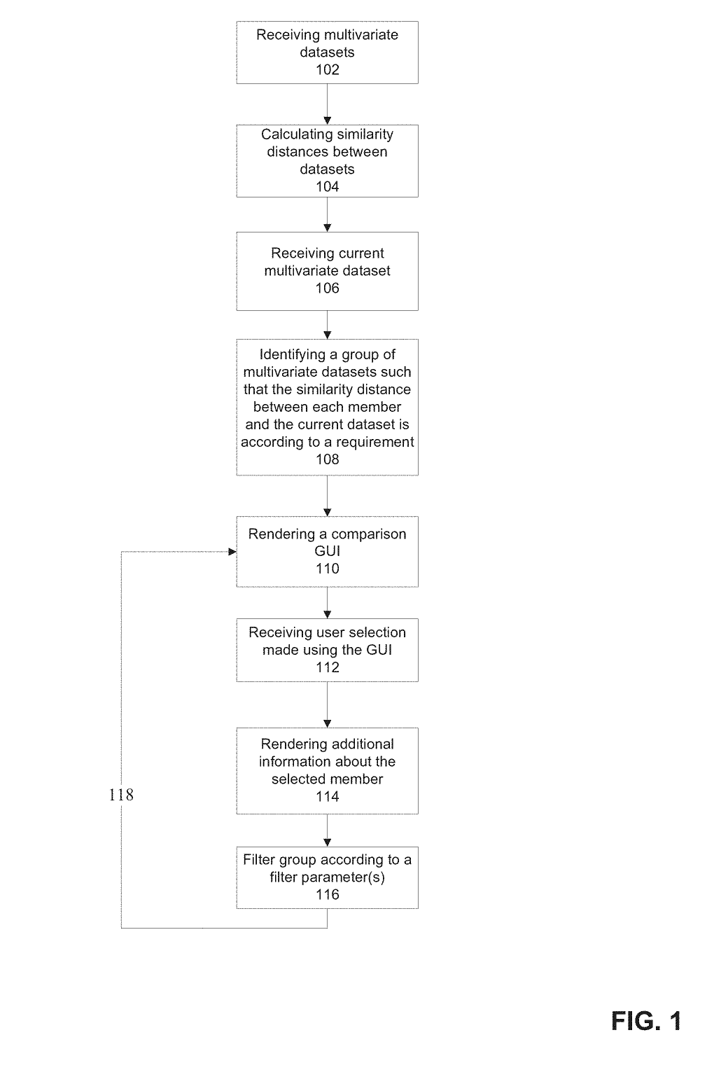

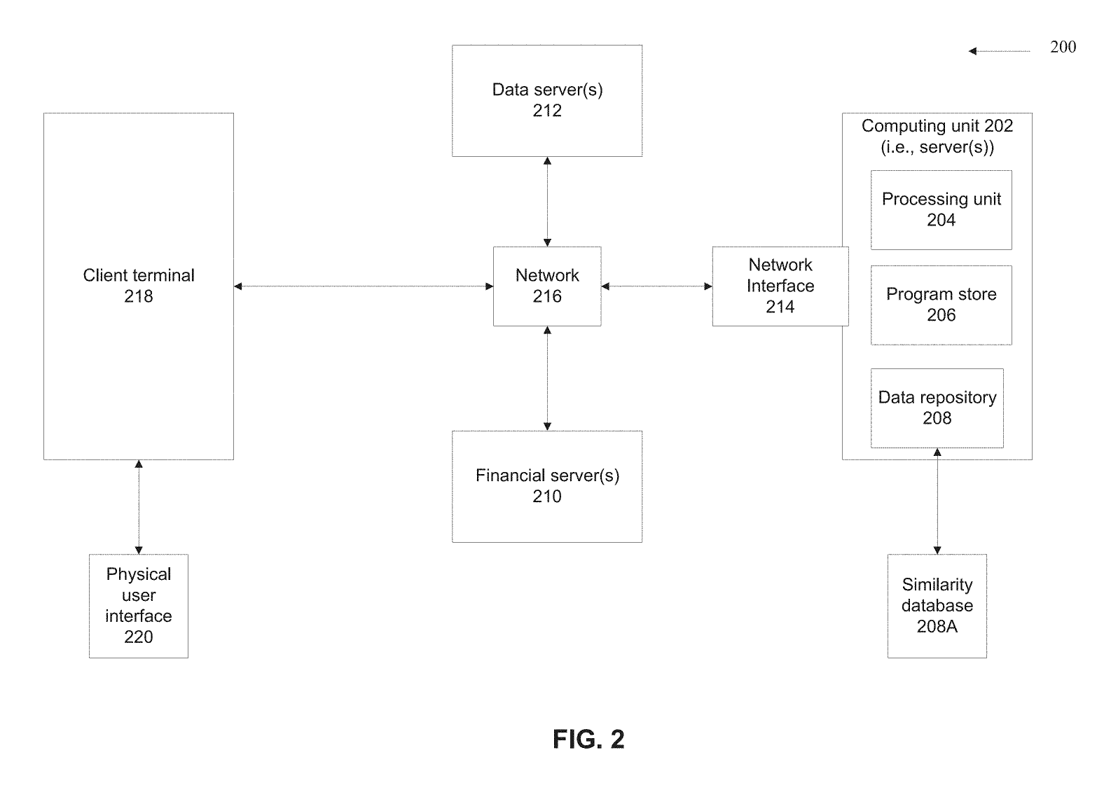

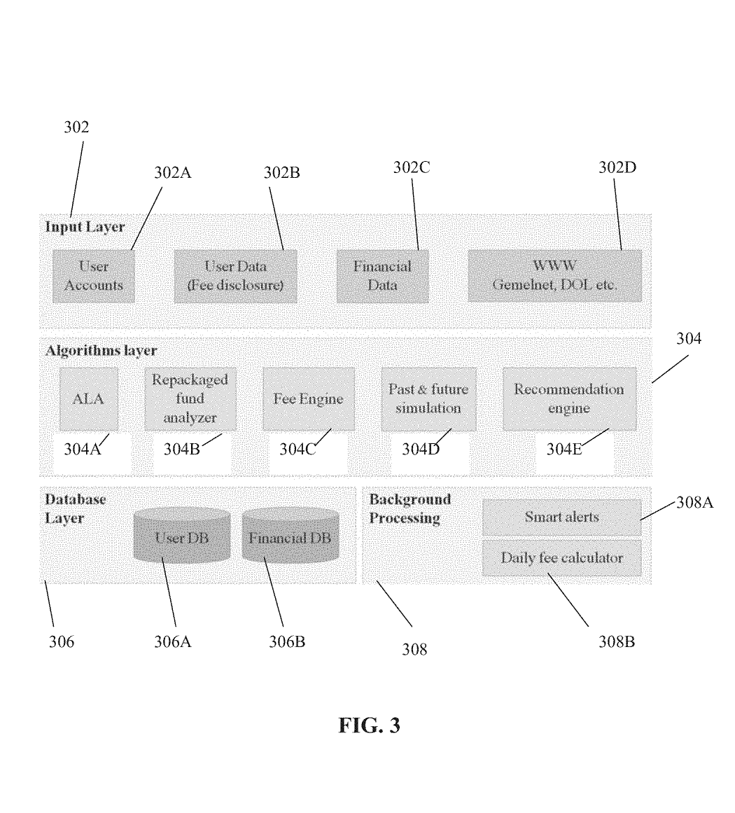

Reference is now made to FIG. 1, which is a flowchart of a process of automatically generating a navigation tool (e.g., GUI) for routing between investment vehicles represented as datasets, according to user input received using the GUI, in accordance with some embodiments of the present invention. Reference is also made to FIG. 2, which is a block diagram of components of a system that receives user input using a GUI, renders a comparison between different vehicles (relative to a vehicle provided by the user), and renders additional information about a selected vehicle, in accordance with some embodiments of the present invention. The systems and/or methods described herein provide easy navigation for a user through a set of financial investment vehicles (represented as datasets) using the GUI associated with a physical user interface. The method of FIG. 1 may be executed by the system of FIG. 2.

System 200 includes a computing unit 202, for example, a server, optionally a web server. Computing unit 202 includes a processing unit(s) 204, for example, a central processing unit(s) (CPU), a graphics processing unit(s) (GPU), field programmable gate array(s) (FPGA), digital signal processor(s) (DSP), and application specific integrated circuit(s) (ASIC). Processing unit 204 may include one or more processors (homogenous or heterogeneous), which may be arranged for parallel processing, as clusters and/or as one or more multi core processing units.

Computing unit 202 may communicate with client 218, for example, by providing software as a service (SaaS) to client 218, providing an application that performs rendering (as described herein) for local download to client 218, and/or providing functions using a remote access session to client 218 such as through a web browser.

Computing unit 202 includes a program store 206 storing code implementable by processing unit 204, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Computing unit 202 may include multiple computers (having heterogeneous or homogenous architectures), which may be arranged for distributed processing, such as in clusters.

Computing unit 202 includes a data repository 208 storing database(s), and/or other data items, which may be obtained from remote servers for analysis, such as financial data related to investment vehicles obtained from external server(s), for example, financial server(s) 210 and/or from data server(s) 212, as described herein. Data repository 208 may include or be associated with a similarity dataset 208A that maps a documented similarity distance between each pair of multivariate datasets (representing investment vehicles). Datasets may be stored, for example, as tables, as linked tables, as databases, using a document based method that stores entire objects, using a key-value based method, or other methods.

Computing unit 202 includes a network interface 214 for communication with a network 216, for example, the internet, a private network, a cellular network, a wireless network, a local area network, or other networks. Computing unit 202 may access financial server(s) 210 and/or data server(s) 212 over network 216.

Computing unit 202 may be in communication with one or more client terminals using network 216, for example, a personal computer, a mobile device (e.g., Smartphone, Tablet), a wearable device (e.g., computing glasses, computing watch), and/or a server. Each client terminal includes one or more physical user interfaces 220 which allow a user to view presented data and/or input data, for example, one or more of: a display, a touch-screen, a keyboard, a mouse, and voice activated interface. It is noted that computing unit 202 may be associated with physical user interface 220, for example, as a thin client, a kiosk, or a web browser.

The interactive GUI (as described herein) may be presented on physical user interface 220, for example, within a web browser.

At 102, multivariate datasets, each comprising documented value(s) of service parameter(s) are received. Each dataset represents a financial investment vehicle. Optionally, the multivariate datasets are created from raw data related to multiple financial investment vehicles.

The financial raw data and/or datasets may be received by code instructions stored in program store 206, implementable by processing unit 204. Financial raw data and/or multivariate dataset may be automatically retrieved from financial server 210 and/or data server 212, by code programmed to access the servers over network 216 and parse information from the website to extract the raw data, data may be uploaded to computing unit 202 by respective servers, data may be manually entered by a user using physical user interface, and/or other methods of data entry may be used. Received data may be stored in data repository 208.

Financial servers 210 may be servers of financial institutions, for example, web servers of investment vehicles, and government regulatory bodies that report on activity of vehicles. Data servers 212 may be servers of other data, for example, news sites reporting performance of vehicles, and third party investment analysis entities that provide analysis reports.

Raw data may be obtained by parsing online materials (e.g., text, and/or images from the web pages of financial institutions), parsing online documents (e.g., text documents, published reports), and/or by accessing a database containing materials.

Optionally, raw data is processed and/or organized (e.g., by code of program store 206) into a suitable data structure, such as multivariate datasets including multivariate objects. Optionally, each financial investment vehicle is stored as a multivariate dataset. Optionally, service parameters of each vehicle are stored as multivariate objects.

Optionally, fee related information is received (and/or identified) for each vehicle. The fee related information may be considered as a service parameter. The fee related information may be stored as a multivariate object, representing different types of fees and respective values. Fees may be charged based on events (e.g., buying or selling), may be charged based on time (e.g., yearly management fee), and/or may be a one time charge (e.g., advisor fee). For example, the fee related information may include one or more of the following parameters: expense ratio, recurring fees, one time fees, commission, wrap fees, transaction (e.g., buy/sell) fees, advisor fees, and/or miscellaneous operating fees (e.g., interest on loans, transfer fees, mail fees).

Code may identify fees, for example, from a source that explicitly states the fee charged for the vehicle. Code may perform calculations to derive fees that are not explicitly stated, for example, fees for vehicles may be calculated from user inputted data (e.g., other users using the system), such as by comparing a deposited amount with the actual amount in the account, such as from a yearly report submitted by the user. For example, a deposit of $1000 that translates into holdings of $950 may represent a $50 commission or transaction fee. Code may identify fees by performing an analysis to identify one or more keywords in proximity to financial values. Keywords may be known words used in the industry, or terms or words identified from financial datasets provided by users of the system. Code may associate each identified fee with the event or time frame for charging the fee, for example, per quarter, monthly, annually, or one time.

Alternatively or additionally, the service parameter of each vehicle is related to inclusion of the vehicle in one or more 401(K) and/or ability to include the vehicle in an IRA. The plan related information may be stored as a multivariate object, representing which plans the vehicle belongs to. For example, certain 401(K) plans may require that the user choose from a limited set of vehicles. IRA plans may allow the user to choose from a larger set of vehicles. Vehicles may be switched between 401(K) and IRA plans.

Alternatively or additionally, the service parameter of each vehicle is related to the actual financial assets that the vehicle holds (i.e. invests in), which is mostly relevant for managed funds, for example, top holdings (e.g., individual stocks, individual bonds, or other individual holdings of a significant percentage of the portfolio), country (or countries), region of investment (e.g., Europe, emerging markets), sector (e.g., energy, telecommunication, healthcare), state (e.g., for municipal funds). The held financial asset related information may be stored as a multivariate object.

Alternatively or additionally, the service parameter of each vehicle is related to an overall investment strategy, outlook, and/or goal, for example, a fixed income fund, a dividend fund, a growth fund, a stock fund, a balanced fund, a sector fund, and a precious metal fund. In another example, the service parameter includes an asset allocation, for example, percent requirements for each asset, such as percent portfolio range in stocks, bonds, and cash. The vehicle strategy related information may be stored as a multivariate object.

Alternatively or additionally, the service parameter of each vehicle is related to an investment approach of individual holdings, such as service parameters of individual assets acquired by the vehicle, for example, bond term, average credit quality (e.g., for fixed income funds), and/or top municipal sectors (e.g., for fixed income funds).

Alternatively or additionally, the service parameter of each vehicle is related to an investment category and/or rank (which may be proprietary), optionally created by an external entity, such as a third party investment research firm, for example, Morningstar Rating™, Morningstar Analyst Rating™, and Morningstar Style Box™ The investment category and/or related information may be stored as a multivariate object.

The service parameter may include a type parameter, which may represent the type of vehicle, such as according to one or more of: the investment category and/or rank, investment approach, investment strategy, actual holdings, and/or retirement plan designation.

Alternatively or additionally, the service parameter of each vehicle is related to purchase of derivatives and/or other leveraging instruments, for example, futures, puts, calls, and borrowing funds. The leveraging related information may be stored as a multivariate object.

Alternatively or additionally, the service parameter of each vehicle is related to exchange currency risk (and/or hedging of such risk), for example, due to purchases of financial assets using foreign currency and/or foreign currency holdings. The exchange currency risk may be stored as a multivariate object.

Alternatively or additionally, the service parameter of each vehicle is related to transaction activity (i.e., by the fund manager), such as buying or selling of assets, for example, turnover ratio, and average length of time each financial asset is held. The transaction activity related information may be stored as a multivariate object.

Alternatively or additionally, the service parameter of each vehicle is related to the financial performance of the vehicle, for example, 12 month yield, past returns (e.g., percent increase over 1, 3, 5, or 10 years), and securities and exchange commission (SEC) yield. The financial performance related information may be stored as a multivariate object.

Service parameters may be related to the type parameter (or to other service parameters), such as parameters related to asset holdings of the vehicle. Optionally the service parameters include a term parameter, optionally related to debt instruments, for example, the bond terms held by the fund. Optionally, the service parameters include a quality parameter, optionally related to debt instruments, for example, the quality rating of the debt asset held by the fund.

Optionally, the received data includes data for repackaged vehicles. Repackaged vehicles may include one or more underlying funds, which are repacked to create the repackaged fund. For example, a mutual fund that invests in other mutual funds. Optionally, code analysis external data to derive one or more service parameters of the packaged vehicles, for example, calculating the service parameters of individual underlying vehicles to estimate or calculate the service parameter of the vehicle that invests in the individual underlying vehicles, such as by semantic analysis and/or calculation of dividends based on daily price changes. The code may analyze data entered by other users holding the same vehicle to try and derive one or more vehicle service parameters, for example, different users that access the system at different points in time holding the same repackaged fund may provide data points of the fund at the different points in time. Code may analyze the underlying vehicles with other known vehicles to identify matches, for example, analyzing fund codes (e.g., exchange traded fund symbols) and/or fund names (e.g., by semantic analysis).

The derived service parameters may be stored as datasets and/or objects in repository 208, for example, as a database, as a table, as links, and/or other representations. Optionally, the values of the service parameters are stored in a database linked (or integrated with) similarity database 208A.

At 104, similarity scores (representing similarity distance) are calculated between each pair of the multivariate datasets. The calculated similarity scores may be stored in similarity database and/or dataset 208A. Alternatively or additionally, at least some similarity scores are calculated in response to receiving user data, for example, when the user logs in and accesses the comparison GUI (e.g., calculated on the fly, and/or in response to block 106, and/or as part of block 108). In such a case, the dynamically calculated similarity scores may be stored in a similarity dataset, which may be a temporary dataset storing scores calculated for the current user session. The dynamically calculated similarity scores may be stored in the database for future access. Some similarity scores may be recalculated, such as to update the scores.

As used herein, the terms similarity database and similarity dataset are sometimes interchangeable.

The similarity score between vehicles may be calculated based on the service parameters assigned to each vehicle (e.g., as described in blocks 102 and/or 106), represented by the multivariate objects of each dataset.

The similarity score may be calculated by summing an outcome of different distance estimation functions each defined for a service parameter. For example, for the service parameter bond term, long terms which differ by a few years may have a high similarity score (e.g., 1), since a 25 year term and a 20 year term may effectively be the same in terms of financial investing. For example, for the service parameter country, the estimation function may output a binary similarity score, allowing only for the option of the same country or different countries. Other examples of estimation functions include: a table of values that maps input values of service parameters to values of similarity scores, a function that selects a maximum value between different values and outputs the similarity score based on the maximum value, and a function that performs a mathematical operation on the value of the service parameter to calculate the similarity score. The service parameters may be associated with a weight for use in calculation of the similarity score. The set of values created by the different functions may be normalized, averaged, optionally weighted, and/or aggregated using other methods, to calculate the score. The similarity score itself may be normalized, for example, the sum of outputs of the estimation functions may be outputted.

The similarity score for the vehicles may be calculated and/or vehicles may be identified, based on a multidimensional space storing the multivariate datasets based on values assigned to each service parameter. For example, each vehicle may be plotted as a point in the space based on the vehicle service parameters. The vehicles that have the lowest statistical distance (e.g., according to a requirement such as a threshold) to the user vehicle may be identified. K-Nearest-Neighbors (KNN) is an exemplary method that may be used to calculate the statistical distance to identify the most similar vehicles.

The distance may be a Euclidean distance calculated in a multidimensional space, from the user dataset to the other datasets (e.g., to each dataset). Each service parameter may define a dimension. Each dataset may be represented as a point in the multidimensional space defined by respective values of the service parameters.

It is noted that heuristic methods may be employed to calculate the scores for the nearest vehicles and/or identify the closest vehicles. The heuristic method may exclude vehicles from consideration which (if fully calculated) may have a very low similarity score. Detailed calculations of the score may be performed on the remaining vehicles.

Alternatively or additionally, the similarity score for the vehicles may be calculated using one or more correlation functions, for example, applying the function to a pair of datasets, a pair of objects, and/or applying the correlation function to each pair of corresponding service parameters to calculate a correlation value for each pair. The set of correlation values may be normalized, averaged, optionally weighted, and/or aggregated using other methods. Other comparison methods may be used.

Optionally, the similarity score of the vehicles may be calculated based on weights assigned to the service parameters. The assigned weights may be manually set by a user, automatically by code (e.g., based on an analysis of the service parameters), and/or based on a predefined system configuration. For example, a user may assign a low weight to the type (e.g., asset mix) service parameter, which may allow for selection of a wider range of different vehicle types.

Optionally, a single similarity score is calculated representing the degree of similarity between the vehicle owned by the user and one of the available vehicles. The similarity score may be a normalized score, or an absolute score. The similarity score may be on a scale, for example, 100-0, or 1-0. 0 may represent no similarity (e.g., opposite) and 100 or 1 may represent identical vehicles.

It is noted that some service parameters may be used to calculate the similarity score, and/or used to selected the suggested vehicles from the set of identified similar vehicles (e.g., as a factor used as a filter). For example, past vehicle returns may be used to identify similar vehicles, and/or used for suggesting the vehicle (e.g., according to best results of the most similar vehicles).

Optionally, for service parameters relevant to certain vehicles and not relevant to other vehicles (e.g., credit quality related to funds that hold bonds, but not to funds that only hold stocks), such service parameters may be weighed proportionally (e.g., when similarity of the credit quality is 0.8 and the fund owns 40% bonds, the similarity score may be calculated as 0.32), and/or excluded when not applicable to the user and the fund from the available funds.

At 106, a current multivariate dataset(s) that includes current values of the service parameters is received (e.g., by code of computing unit 202). The current multivariate datasets may each represent a financial investment vehicle of a user, such as vehicles held in a retirement account and/or investment portfolio.

Optionally, raw financial data related to the financial portfolio of the user is received, such as by computing unit 202. The dataset may be generated from the raw data (e.g., as described with reference to block 102). The portfolio data may include raw data of one or more financial vehicles held by the user. The raw data and/or dataset may be obtained, for example, manually entered by the user (e.g., using the physical user interface of the client terminal) such as by the user selecting from a list of vehicles (e.g., having associated datasets stored in data repository 208) and/or manually entering all details, may be automatically extracted from a photo captured of portfolio reports (e.g., using optical character recognition retrieving data from an image of pages of the report captured using a camera of a smartphone), and/or automatically extracted from an online client account of the user used to manage the vehicle and/or portfolio (e.g., by linking or granting access to the online account(s) on financial server(s) to the computing unit).

The raw data of the user may be organized into multivariate dataset(s) (e.g., for each financial vehicle of the portfolio) of multivariate objects, as discussed with reference to block 102. It is noted that the financial vehicles held by the user may already be known to the computing unit (e.g. stored in the repository). In such a case, the vehicles of the user may be mapped or obtained from the repository.

It is noted that as described herein, data provided by users of the system may be analyzed to improve performance for other users. For example, determining service parameters of a vehicle may be improved by analyzing data (e.g., yearly/quarterly financial reports) submitted by other users of the same vehicle, optionally at different points in time.

Optionally, the user submits additional details at different points in time, for example, the user may submit scanned quarterly financial statements. The code may analyze the data over time to improve the ability in determining service parameters of the held vehicle, for example, to detect fees.

Optionally, code may perform a reverse engineering analysis of the user submitted data to more precisely calculate fees that the user is paying. There may be different ways to calculate fees, for example, on a daily basis, on a monthly basis, or on a quarterly basis. The code may analyze the data to try and determine the specific fee calculation method employed by the vehicle(s) held by the user.

At 108, a group of one or more multivariate datasets, which may represent available vehicles (e.g., vehicles the user may replace the analyzed vehicle with, such as vehicles in the same 401(K) or vehicles available after a roll-over to an IRA) may be identified for each vehicle provided by the user (e.g., in block 106), for example, each vehicle in the portfolio of the user. The group may represent the vehicles that are most similar to the vehicle of the user.

Optionally, the group is identified using similarity dataset 208A which stores similarity score(s) representing similarity distances between each member of the group of multivariate datasets (representing available vehicles) and the user vehicle (i.e., the current multivariate dataset).

Optionally, the group is identified according to a requirement, for example, a threshold, a range, and/or a function. Members of the group have similarity distances above or below the threshold requirement, for example, the threshold may be 85% similarity score, and members of the group are those vehicles with greater than 85% matching scores.

Optionally, the group is identified according to the combination requirement. The members of the group may include vehicles that achieve a tradeoff in the balance between closest similarity (and/or closest distance) and largest improvement in the improvement parameters. The tradeoff may be defined, for example, as X units in distance allowed for Y units in improvement of the improvement parameters, or example for every increase in distance of 0.05 units the improvement parameter (e.g., for fees) should be a fee decrease of 0.3%. In this manner, the vehicles with lowest fees but not moving too far away may be identified. Alternatively, the group is first identified according to the similarity score, with a subgroup (i.e., the suggested vehicles) identified from the first group according to the improvement in the improvement parameters. In such a case, the improvement parameter may be selected by the filtering parameters.

It is noted that when the score is calculated, the vehicles may be determined by one or more filter parameters which may be applied the group of vehicles (e.g., as described with reference to block 110). The identification and/or score calculation may be performed by code stored in program store 206 implementable by processing unit 204.

At 110, a comparison GUI is rendered according to the group of most similar multivariate datasets. The GUI is presented on the physical user interface, such as a screen. The GUI presents a comparison between at least some of the documented values of the service parameters for each member of the group, and with the user vehicle. In this manner, the user may visually compare the currently owned vehicle with other potential vehicles.

Optionally, one or more vehicles are marked as suggested vehicles, according to service parameter values that are different, optionally having very different distances as compared to service parameter values of the user vehicle. Optionally, the service parameters used for comparison include fee related data. Alternatively or additionally, the service parameters include past vehicle performance and/or estimated future performance. In such a case, the suggested vehicles may include vehicles from the group of similar vehicles that have the lowest fees (e.g., lowest distance calculated for the fees) and/or highest returns as compared to the user vehicle. In this manner, the user may quickly and visually compare how switching from the current vehicle to an alternative similar vehicle would affect the user's finances, in terms of lower fees and/or improved performance.

Optionally, the top several vehicles are presented according to one or more service parameters compared to the user vehicle, for example, vehicle related fee(s). The top vehicles may be defined as having the largest distance in terms of the service parameter, for example, the lowest fees. The top vehicles may be defined based on a number (e.g., top 5 or 10 vehicles), or ordered in order of decreasing distance, or all vehicles (e.g., above the similarity requirement) available to the user (e.g., by scrolling). In this manner, the user may select to switch to vehicles having lower fees, while maintaining the current asset make-up of the portfolio, for example, in terms o asset mix, and type of vehicles.

It is noted that other values used for comparison of the datasets may be calculated, and may not necessarily be included as service parameters. For example, fund fees(s) (or some fee types) and/or vehicle performance (e.g., estimated future performance or past performance) may be used to select recommended vehicles and/or top several vehicles, and/or used for filtering. For example, from the set of most similar datasets, vehicles with lowest fees and/or best estimated future performance may be selected based on calculated (or estimated) account fees and/or predicted future performance.

Predicted future performance and/or fees paid may be calculated, for example, based on predicted future deposits made by the user into the vehicle (e.g., purchase fees may be higher for multiple small deposits compared to one large deposit). Such predictions may be made by analyzing past user behavior, which may be provided to the system, for example, by a yearly summary of transactions statement, based on past user activity of the system, based on manual user input, based on extraction of data from a user financial account, and/or based on behavior of other similar users.

The vehicles selected for comparison may be selected based on service parameters (and/or other values) estimated in a future time frame, for example, in 30 years, or at retirement. Such comparison may include, for example, estimated future value of the vehicles, based on potential savings in fees and/or improved financial performance. As savings in vehicle related fees leaves over more money in the vehicle available for compound growth, such comparisons based on future estimated values may be more significant. Estimates in growth may be performed using long term average rates (e.g., over 25 or 30 years), ignoring short term swings in values, which may balance out over the long term.

At 112, a user selection made using the comparison GUI is identified, for example, a click on a link, a finger pressing on an icon, data manually typed into a blank field, and/or a selection made from a list.

The selection includes a selected member of the group of most similar vehicles, optionally one of the suggested vehicles. For example, the user scrolls through the different vehicles and clicks a link on a certain vehicle.

At 114, additional information about the selected member is rendered in response to the selection by the user. The additional information may be transmitted from the computing unit to the user interface of the respective client terminal. The additional information is presented within the comparison GUI, for example, the GUI is updated to include the user vehicle and the presented vehicle, such as organized in a table for comparison.

The additional information may include one or more of the service parameters. The subset of service parameters selected for the additional information may be predefined as a system configuration, manually selected by the user, and/or automatically selected by code, such as to highlight significant differences between the similar vehicles, such as differences in fees.

Optionally, at 116, the group of similar datasets is filtered according to at least one selected filter parameter or zero filter parameters. The filter parameter may be provided by the user, using the GUI. The filtered datasets are presented in the GUI.

Optionally, the GUI includes multiple filter parameters, which may be presented as GUI elements, for example, icons which may be clicked, a field for manually entering data, a drop down list for selection of filtering values, and/or a checklist of filter parameters.

Optionally, the filter parameters are based on the service parameters. Alternatively or additionally, the filter parameters are based on other calculated factors (i.e. not used for the service parameters). The subset of service parameters selected for filter parameters may be predefined as a system configuration, manually selected by the user, and/or automatically selected by code, such as to highlight significant differences between the similar vehicles, such as differences in fees.

Optionally, the filtering parameters include the improvement parameter(s) described herein. Filtering using the improvement parameter(s) may identify the vehicles with greatest improvement in the filtered improvement parameter, for example, lowest fees. The stepwise process of first selecting the closest vehicles and then filtering by improvement parameters may provide the user with control over which improvements are desired. The combination requirement (i.e., simultaneous vehicle selection based on the combination of similarity and improvement parameters) may achieve the best balance between similar vehicles that have the greatest improvement.

Examples of filter parameters include: fees, vehicle type, and vehicle performance (past, actual, and/or predicted).

At 118, changes in the filter parameters are received. The user may dynamically enter changes using the GUI, for example, by entering different values and/or clicking on different filter options. The filters are re-applied to the group of similar datasets, to render a new comparison GUI, optionally by iterating blocks 110-116.

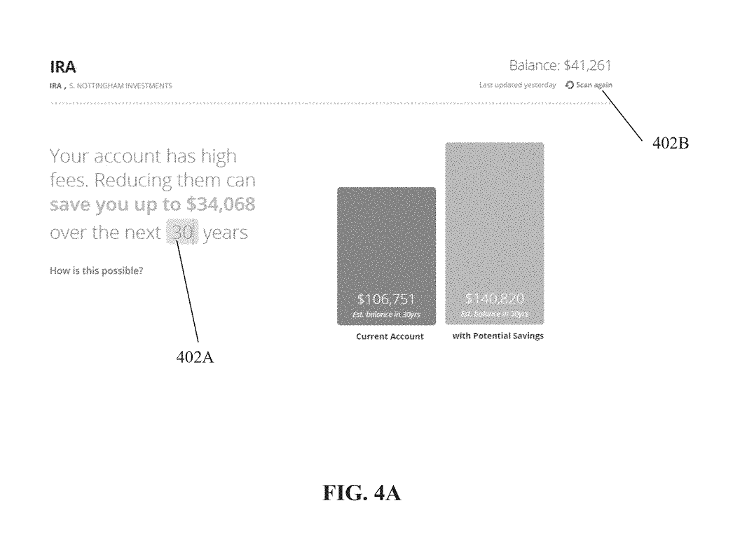

FIG. 3 is a data diagram of different data components for implementation of the method of FIG. 1 and/or used by the system of FIG. 2, in accordance with some embodiments of the present invention.

Input layer 302 includes the data provided for processing, for example, to computing unit 202, from the physical user interface 220 of client terminal 218, financial server 210, and/or data server 212. User accounts 302A may include data to allow the system to access financial accounts on financial servers 210 held by the user for automatic extraction of data related to vehicles held by the user. User data 302B may include data provided by the user (e.g., a scanned image of a portfolio or vehicle financial report of assets held by the user) which may be analyzed to calculate fees paid by the user, and/or analyze user financial behavior patterns (e.g., deposit pattern). Financial data 302C includes raw data related to the vehicles, used to determine one or more service parameters of the datasets, for example, obtained from financial servers 210. Other data 302D includes other raw data obtained from different sources, such as web servers, government databases, third party analysis entities, news sites, or other sources, which may be used to determine additional service parameters of the datasets, for example, obtained from data servers 212.

Algorithm layer includes code (e.g., stored in program store 206) implementable by the processing unit (e.g., 204). Account link analysis (ALA) 304A includes code to access financial user accounts (using user accounts 302A) to retrieve data related to vehicles held by the user. Repackage vehicle analyze 304B includes code to analyze repackaged vehicles, to calculate service parameters for such vehicles based on identifying held underlying vehicles, and/or by deviation calculations using other available data (e.g., change in value over time to calculate dividend payouts). Fee engine 304C includes code to calculate fees of each vehicle and/or fees paid by the user. Past & future simulation 304D includes code to calculate past performance of vehicles and/or to predict future performance of vehicles (e.g., based on the past performance and/or other factors). Recommendation engine 304E includes code to identify the closets matching vehicles to the vehicles held by the user, and recommend one or more vehicles, for example, based on lower fees and/or increased returns.

Database layer 306 includes stored data (e.g., stored in data repository 208). User database 306A stores data provided by users of the system, for example, vehicles held by each user, buy/sell activity of each user, and/or fees paid by each user. Financial database 306B stores raw data and/or derived service parameters of available vehicles, optionally as multivariate datasets including multivariate objects. Financial DB may store the similarity distances between different vehicles.

Background processing layer 308 includes code to perform background calculations. Smart alerts 308A may include code that analyzes updated information of vehicles to detect new recommended vehicles to the user. Upon detecting a change for a previous recommendation, an alert may be transmitted to the user indicative of the new recommendation (e.g., an instant message to a smartphone, a phone call, and/or an email). Daily fee calculator 308B may track updates in vehicle prices and/or vehicle activities to detect new fees and/or hidden fees.

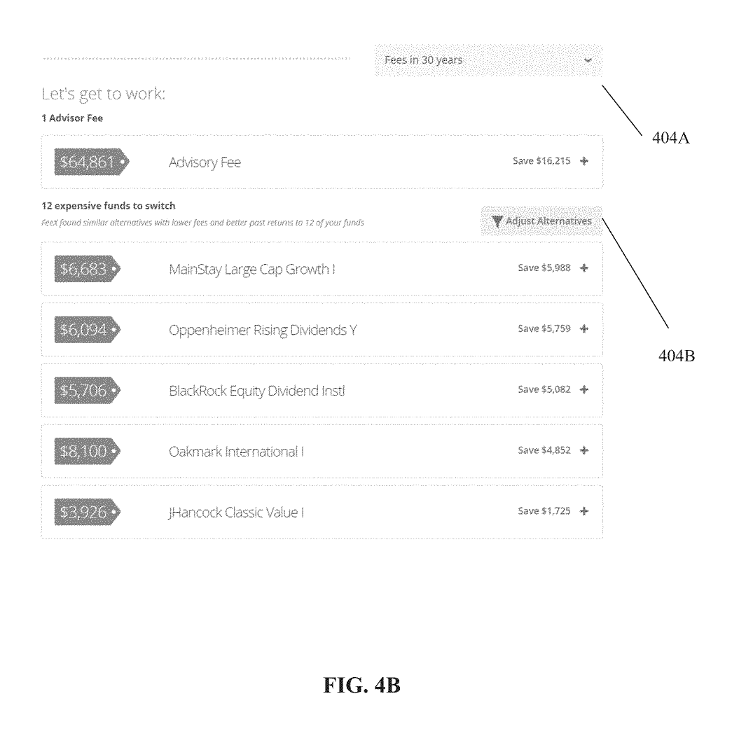

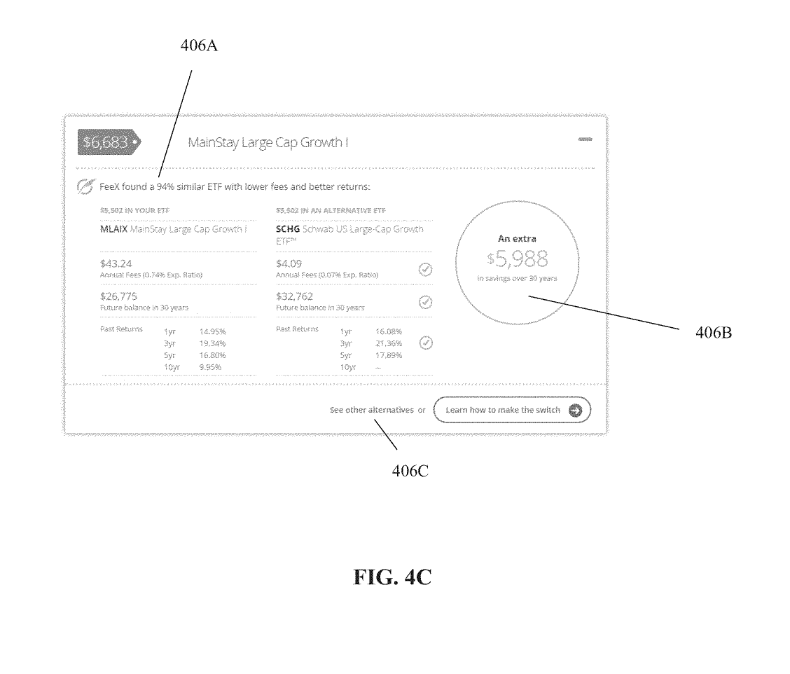

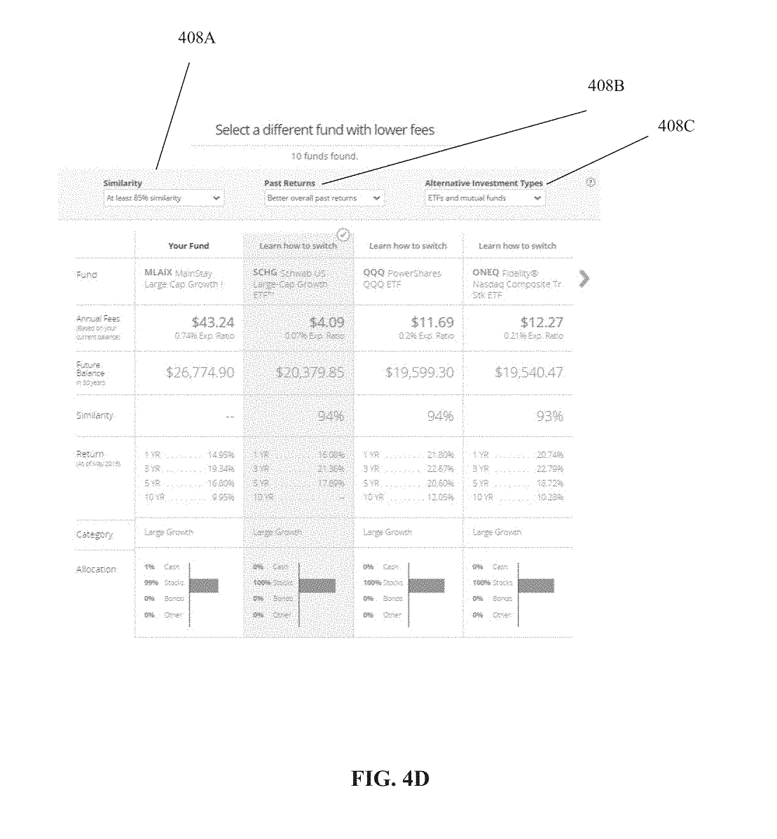

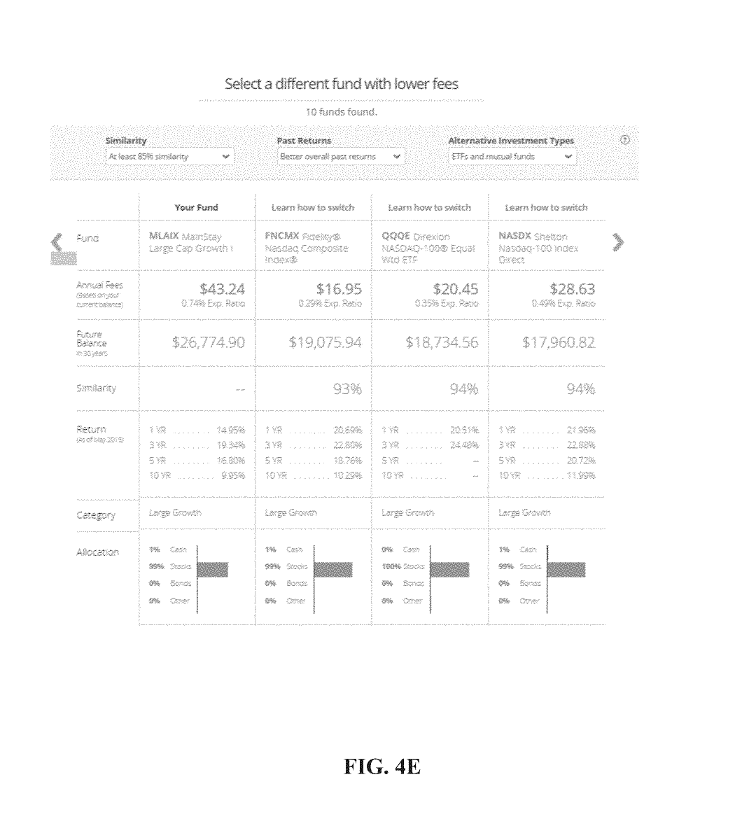

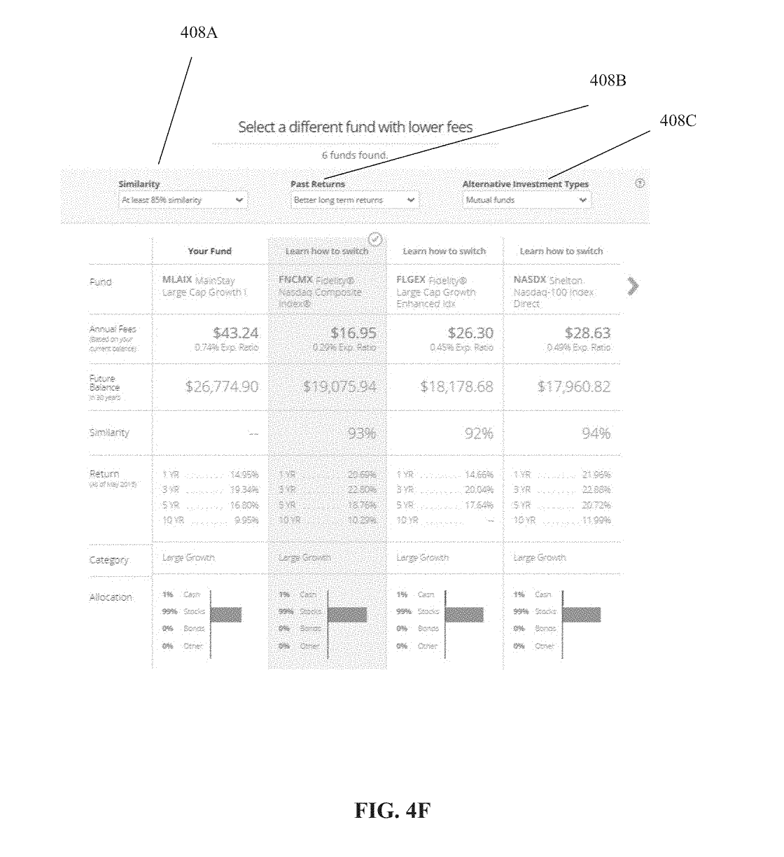

FIGS. 4A-4F are screen captures of an exemplary implementation of the method of FIG. 1, and/or the system of FIG. 2, in accordance with some embodiments of the present invention. The screen captures illustrate a comparison GUI having user input elements (e.g., buttons, links, and/or data entry fields) that allow the user to make a selection for further comparison and/or filter parameters to filter the datasets. FIGS. 4A-4F depict use of the comparison GUI to identify alternative datasets based on the vehicle related fee service parameter, by selecting vehicles with lowest fees.

FIG. 4A is a screen capture that compares the overall current account value of the user financial account (e.g., as entered by the user and/or retrieved and stored in a user entry) to statistically matched vehicle(s) having reduced vehicle related fees as compared to the current vehicles held by the user. In field 402A the user may enter the number of future savings years (e.g., years to retirement). In field 402B the code may obtain updated information for vehicles (e.g., updated charged fees, updated vehicle returns, updated vehicle prices). Based on the input, the code identifies the best matching datasets having lowest similarity distance, and predicts the total potential savings based on the number of years and savings in fees for the best matched datasets.

FIG. 4B is a GUI that allows the user to dynamically navigate between different individual vehicles (which are statistically similar to vehicles currently held by the user) according to estimated fees saved by each vehicle. Field 404A allows the user to enter the number of future years for future fee payment estimation. The GUI then dynamically navigates to the closest vehicles identified with lowest fees. Field 404B allows the user to select filters of the statistically matched vehicles, to dynamically navigate within the matched vehicle according to the filtering criteria.

FIG. 4C is a GUI that presents a comparison of the service parameters of a vehicle held by the user with an identified match (e.g., similarity distance meeting the requirement and having lower fees), for example estimated annual fees, estimated future balance, and past returns. A measure of statistical correlation and/or match (e.g., similarity score) is displayed by field 406A, representing how close the alternative vehicle is to the current vehicle. The total estimated savings for a vehicle over the previous entered time frame is displayed in 406B. The user may navigate to other vehicle alternatives (which may be less statistically correlated and/or having different fees) by selecting link 406C.

FIG. 4D is a GUI that includes filtering parameters to filter the closest matching alternative vehicles (e.g., when the user clicked on link 406C of FIG. 4C). The user vehicle is compared to multiple other vehicles according to one or more vehicle service parameters, for example, fees, future balance, returns, category, and/or asset allocation. The user may enter data to change the filtering parameters to result in different displayed vehicles. Field 408A allows the user to select the requirement for the similarity distance (e.g., correlation) between the user vehicles and the other vehicles, for example, a threshold value for a calculated similarity measure. Fields 408B and 408C allows the user to filter the vehicles to display vehicles with selected service parameters. Field 408B is related to past returns. Field 408C is related to investment types (e.g., exchange-traded funds and mutual funds).

FIG. 4E displays additional vehicles accessible by scrolling from the GUI of FIG. 4D.

FIG. 4F displays an iterated rendering of the GUI in response to user selection of one or more filtering parameters, presenting a dynamic routing to different vehicles meeting the newly selected user criteria. From FIG. 4D, the user changed field 408B to Better long term returns (5 or 10 year), and field 408C to Mutual funds (no exchange traded funds).

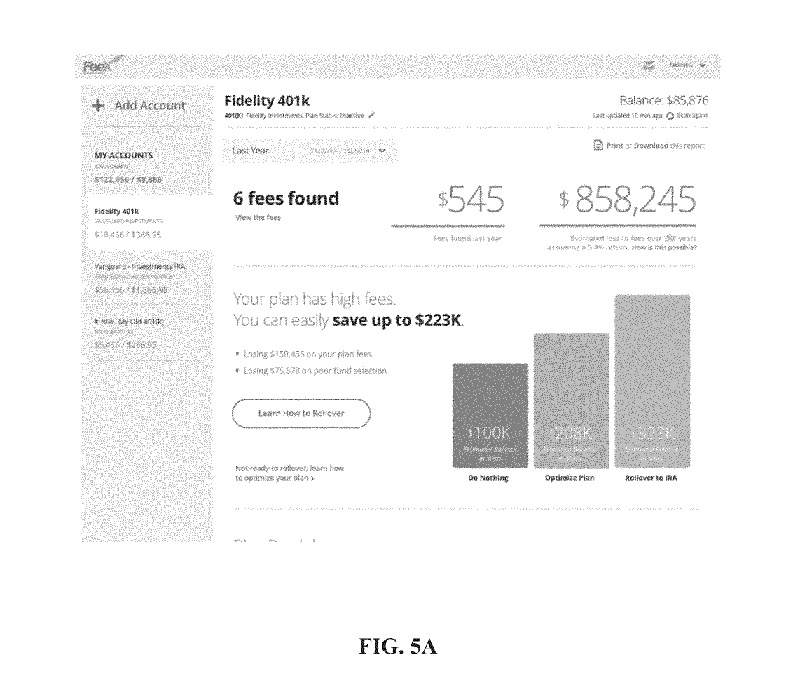

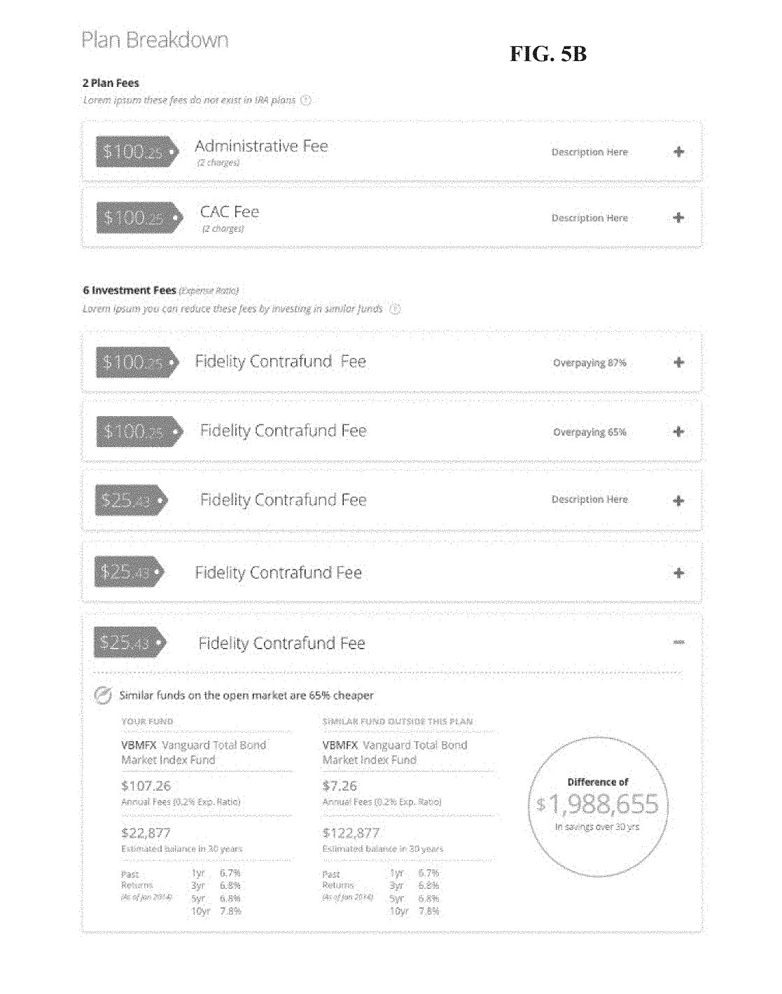

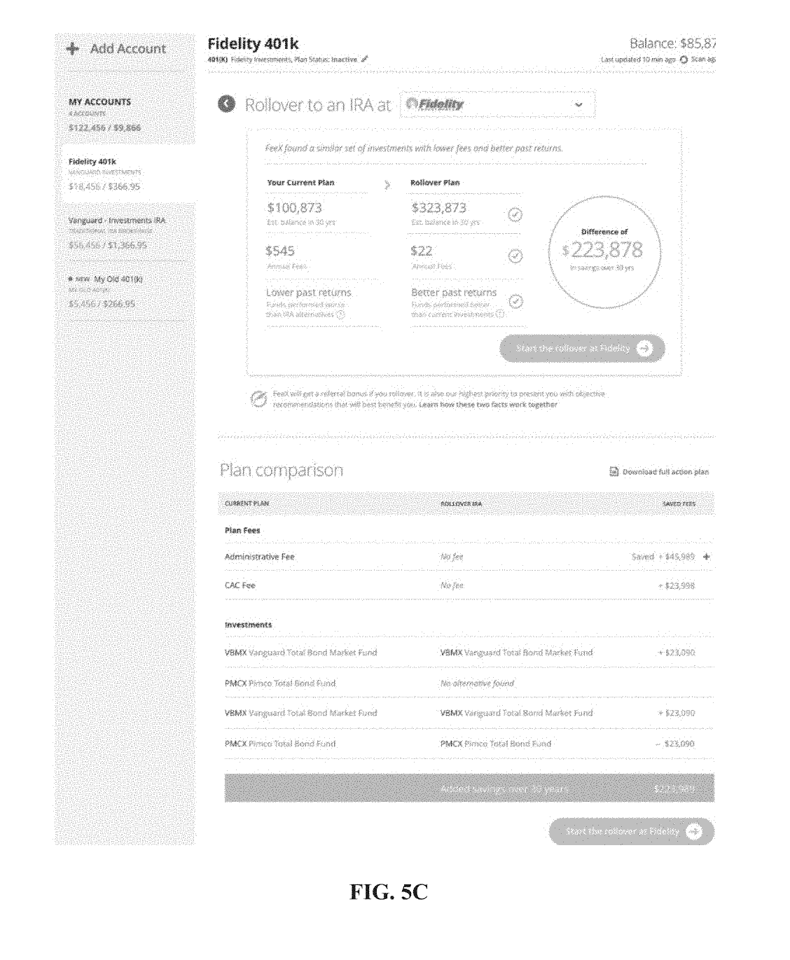

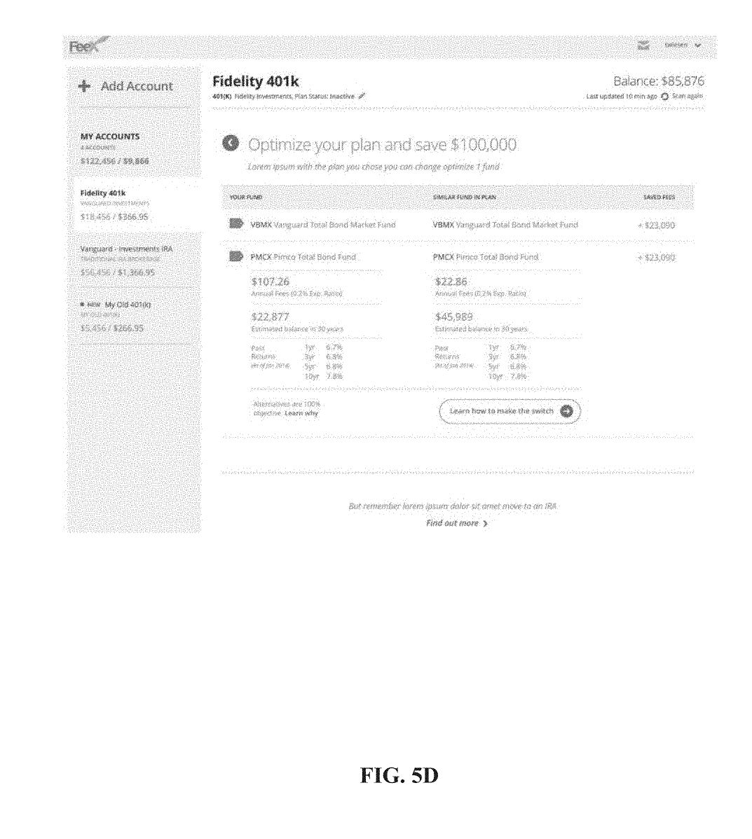

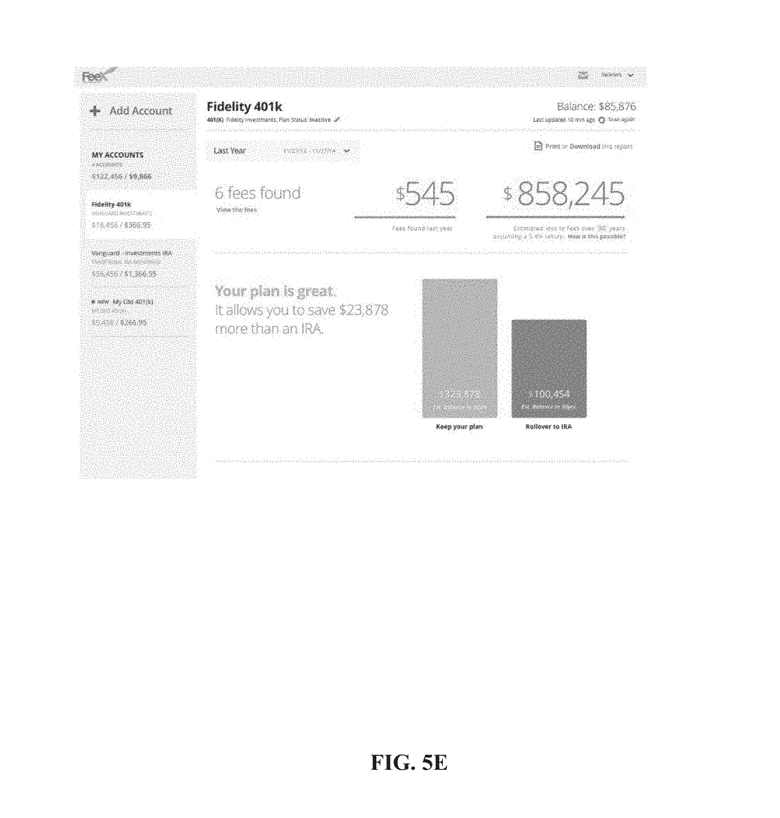

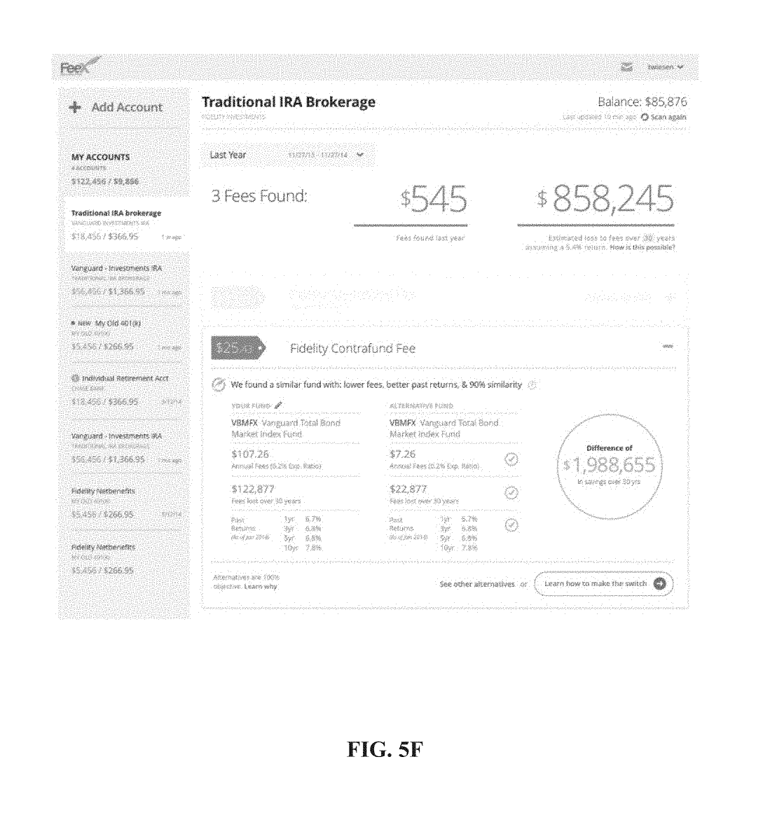

FIGS. 5A-5F are another set of screen captures of an exemplary implementation of the method of FIG. 1, and/or the system of FIG. 2, in accordance with some embodiments of the present invention. The screen captures illustrate an interactive comparison GUI having user input elements (e.g., buttons, links, and/or data entry fields) that dynamically navigates between vehicles in response to the user input. FIGS. 5A-5F depict use of a GUI to identify alternative vehicles by focusing on improving portfolio performance, such as by rolling over from a 401(K) to an IRA.

FIG. 5A is a screen capture of a GUI that compares the overall current account value of the user's vehicle portfolio of a 401(K) plan to statistically matched vehicle(s) in the same 401(K) (optimized plan) and/or to vehicles available in an IRA, based on the identified vehicles having improved predicted performance and/or reduced vehicle related fees as compared to similar current vehicles held by the user. The user may enter multiple 401(K) plans with different entities to analyze each plan.

FIG. 5B is a continuation of the screen capture of FIG. 5A. The GUI presents a breakdown of plan fees (if exist) and the identified fees for each vehicle. The fees being paid by the user are compared to other identified vehicles.

FIG. 5C is a GUI presenting a dynamic routing from the current plan (e.g., 401(K)) of the user to a rollover plan (e.g. IRA). The GUI dynamically navigates to alternatives identified to each existing vehicle. The GUI presents estimates of future savings from each identified vehicle, such as due to reductions in fees.

FIG. 5D is a GUI presenting a comparison of corresponding service parameters of individual identified vehicles in the same 401(K) or other plan (e.g., from FIG. 5C).

FIG. 5E is a GUI presenting a result in which no better alternative has been found. The user is advised to remain with the current set of vehicles in the portfolio and/or remain with the current plan (e.g. 401(K) or IRA).

FIG. 5F is a GUI presenting a comparison of corresponding service parameters of individual identified vehicles in an IRA.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms GUI, and dataset are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of generating a navigation tool, comprising:
managing a similarity dataset mapping a documented similarity distance between each pair of a plurality of multivariate datasets, each one of said plurality of multivariate datasets comprising a plurality of documented values of a plurality of service parameters, each said multivariate dataset stores at least one multivariate object representing fees, said multivariate object including one or more service parameters selected from the group consisting of: expense ratio, recurring fees, one time fees, commission, wrap fees, transaction fees, advisor fees, and miscellaneous operating fees;
receiving a current multivariate dataset comprising a plurality of current values of said plurality of service parameters;
identifying, using said similarity dataset, a group of said plurality of multivariate datasets such that a similarity distance between each member thereof and said current multivariate dataset is below a threshold;
instructing a rendering of a comparison graphical user interface presenting a comparison between at least some of said plurality of documented values of at least some of said plurality of service parameters for each member of said group and estimated fees saved by applying each member of said group instead of said current multivariate dataset;
identifying a selection user made with said comparison graphical user interface of a selected member of said group; and
instructing a rendering of additional information about said selected member in response to said selection user.

2. The method of claim 1, further comprising presenting to a user a plurality of filter parameters and filtering said plurality of multivariate datasets according to at least one selected filter parameter form said plurality of filter parameters.

3. The method of claim 2, wherein at least some of said filter parameters are selected from said plurality of service parameters.

4. (canceled)

5. The method of claim 1, wherein said documented similarity distance is calculated by summing an outcome of a plurality of different distance estimation functions each defined for one of said plurality of service parameters or as a Euclidian distance in a multidimensional space defined by said service parameters, wherein each dataset is represented as a point according to respective values of said service parameters.

6. (canceled)

7. The method of claim 5, wherein said threshold is defined as a predefined number of datasets nearest to the current dataset.

8. The method of claim 1, wherein said plurality of service parameters comprising a term parameter, a quality parameter and a type parameter.

9. The method of claim 1, further comprising identifying a subgroup of said group of said plurality of multivariate datasets according to a combination requirement that balances a tradeoff between said similarity distance and improvement in respective value of a predefined service parameter.

10. The method of claim 1, wherein said comparison further includes a comparison of a simulated forecast for a future time frame based on at least some of said service parameter values.

11. The method of claim 1, further comprising identifying, using said similarity dataset, a subgroup of said group of said plurality of multivariate datasets according to a value of a certain service parameter being below a second threshold or a simulated forecast for a future time frame, said simulated forecast based on at least some of said service parameter values.

12-13. (canceled)

14. The method of claim 1, wherein each dataset represents a different financial investment vehicle, and said current multivariate dataset represents a certain financial investment vehicle owned by the user; wherein at least one of the service parameters is selected from the group consisting of: actual financial assets held by the vehicle, investment strategy, investment category, purchase of derivatives and/or other leveraging instruments, exchange currency risk, transaction activity.

15. The method of claim 1, wherein each dataset represents a different financial investment vehicle, and said current multivariate dataset represents a certain financial investment vehicle owned by the user; wherein said comparison includes a comparison of a simulated financial forecast for a future time frame representing a future balance of the user.

16. The method of claim 1, wherein each dataset represents a different financial investment vehicle, and said current multivariate dataset represents a certain financial investment vehicle owned by the user; wherein the certain financial investment vehicle of the user is part of a 401(K), wherein said different financial investment vehicles include at least some vehicles which are part of an IRA, and said comparison includes a comparison of rolling over from the 401(K) to the IRA.

17. The method of claim 1, wherein each dataset represents a different financial investment vehicle, and said current multivariate dataset represents a certain financial investment vehicle owned by the user; wherein at least one of said different financial investment vehicle and said certain financial investment vehicle are a repackaged vehicle.

18. The method of claim 1, wherein at least some values of the similarity distances are calculated in response to receiving the current multivariate dataset.

19. A system for generating a navigation tool, comprising:
a network interface for communicating over a network with a plurality of client terminals each associated with at least one physical user interface;
a data repository storing a similarity database mapping a documented similarity distance between each pair of a plurality of multivariate datasets, each one of said plurality of multivariate datasets comprising a plurality of documented values of a plurality of service parameters, each said multivariate dataset stores at least one multivariate object representing fees, said multivariate object including one or more service parameters selected from the group consisting of: expense ratio, recurring fees, one time fees, commission, wrap fees, transaction fees, advisor fees, and miscellaneous operating fees;
a program store storing code; and
a processor coupled to the network interface, the data repository, and the program store for implementing the stored code, the code comprising:
code to receive a current multivariate dataset comprising a plurality of current values of said plurality of service parameters;
code to identify, using said similarity database, a group of said plurality of multivariate datasets such that a similarity distance between each member thereof and said current multivariate dataset is below a threshold;
code to render a comparison graphical user interface presenting a comparison between at least some of said plurality of documented values of at least some of said plurality of service parameters for each member of said group and estimated fees saved by applying each member of said group instead of said current multivariate dataset;
code to transmit the comparison graphical user interface to a first client terminal of the plurality of client terminals for presentation on a respective at least one physical user interface;
code to identify a selection user made using said at least one physical user interface with said comparison graphical user interface of a selected member of said group;
code to render additional information about said selected member in response to said selection user; and
code to update the comparison graphical user interface presented on the first client terminal to display the additional information.

20. The system of claim 19, further comprising code to access an external server to parse online materials from said external server and arrange said parsed online materials to obtain said values for said plurality of service parameters.

21. The system of claim 19, wherein the first client terminal comprises a mobile device and said respective at least one physical user interface comprises a touch-screen.

22. (canceled)

23. The system of claim 19, further comprising code to analyze data submitted from a plurality of users of said plurality of client terminals, to estimate values of at least some of said service parameters.

24. The system of claim 19, further comprising code to estimate values of at least some of said service parameters for a certain dataset according to values of service parameters of at least one other dataset, wherein said at least one other dataset represents an underlying dataset of said certain dataset.

25. A computer program product comprising a non-transitory computer readable storage medium storing program code thereon for implementation by a processor of a system for generating a navigation tool, the program code comprising:
instructions to manage a similarity database mapping a documented similarity distance between each pair of a plurality of multivariate datasets, each one of said plurality of multivariate datasets comprising a plurality of documented values of a plurality of service parameters, each said multivariate dataset stores at least one multivariate object representing fees, said multivariate object including one or more service parameters selected from the group consisting of: expense ratio, recurring fees, one time fees, commission, wrap fees, transaction fees, advisor fees, and miscellaneous operating fees;
instructions to receive a current multivariate dataset comprising a plurality of current values of said plurality of service parameters;
instructions to identify, using said similarity database, a group of said plurality of multivariate datasets such that a similarity distance between each member thereof and said current multivariate dataset is below a threshold;
instructions to render of a comparison graphical user interface presenting a comparison between at least some of said plurality of documented values of at least some of said plurality of service parameters for each member of said group and estimated fees saved by applying each member of said group instead of said current multivariate dataset;
instructions to identify a selection user made with said comparison graphical user interface of a selected member of said group; and
instructions to render additional information about said selected member in response to said selection user.
